(19) United States
(12) Patent Application Publication
(10) Pub. No.: US 2005/0232109 A1
(43) Pub. Date: Oct. 20, 2005

(54) Disc recognition method and apparatus

(75) Inventor: Chun-Hsiang Tsai, Taoyuan County (TW)

Correspondence Address: BIRCH STEWART KOLASCH & BIRCH, PO BOX 747, FALLS CHURCH, VA, 22040-0747, US

(73) Assignee: ASUSTek COMPUTER INC.

(21) Appl. No.: 10/992,357

(22) Filed: Nov. 19, 2004

(30) Foreign Application Priority Data
Apr. 16, 2004 (TW) 93110646

(51) Int. Cl. G11B 5/58

(52) U.S. Cl. 369/53.2

(57) ABSTRACT

A disc recognition method. First, a disc apparatus uses a laser with a first wavelength to irradiate a disc, thereby obtaining a first reflection signal, and uses a laser with a second wavelength, larger than the first wavelength, to irradiate the disc, thereby obtaining a second reflection signal. Then, the type of disc is recognized according to the first and second reflection signals.

### BACKGROUND

The present invention relates to a disc recognition method and apparatus, and particularly to a disc recognition method and apparatus that recognizes the type of disc using by lasers with different wavelengths.

Optical storage media are an important step in the evolution of data storage media. With the development of optical storage media, a large amount of data can be recorded and backed up on a light weight disc, thus enabling replacement of traditional data storage media. Among optical storage media, DVDs provide significant advantages in data density and capacity when compared to VCDs and CDs, therefore, there is a tendency to more toward storage of data media, and multimedia data on DVDs.

For DVD players, capable of reading VCDs and CDs, before the DVD-ROM reads data from a disc, the type of the disc is first recognized. After the type of the disc is correctly recognized, the DVD-ROM uses an appropriate laser with a specific wavelength to read data from the disc. The disc structure of both CDs and DVDs has at least a protection layer and a data layer (data reflection layer), with the protection layer being the outermost layer. Additionally, the positions of the data layer of CDs and DVDs are different, in which the data layer of a CD is at 1.2 mm, and a DVD is at 0.6 mm. Therefore, a conventional disc recognition method recognizes a disc according to the position of the data layer of the disc.

During disc recognition, a DVD-ROM uses a laser with a specific wavelength to irradiate the disc, and continues to measure reflection signals during the recognition period. The reflection signals are shown in FIG. 1. As shown in FIG. 1, a first peak value P1 of a wave is measured as the laser irradiates the protection layer of the disc at a first time T1, and a second peak value P2 of a wave is measured as the laser irradiates at the data layer of the disc at a second time T2. Since the thicknesses of the protection layer of CDs and DVDs are different, the time difference between two wave peaks for CDs and DVDs are also different. Thus, the disc can be recognized as a CD or a DVD by comparing the difference between time T1 and T2 (T2−T1).

Since the protection layer is designed to protect but not reflect of laser signals, however, the reflected signals may be too small and escape detection. Further, since there may be noise during operation of the DVD-ROM, the measured reflection signals maybe also suffer from interference, thereby increasing the possibility of misrecognition.

### SUMMARY

According to an embodiment of the invention, a disc recognition method is provided. First, a disc apparatus uses a laser with a first wavelength to irradiate a disc, thereby obtaining a first reflection signal, and uses a laser with a second wavelength to irradiate the disc, thereby obtaining a second reflection signal. Then, the type of disc is recognized according to the first and second reflection signals.

The laser with the first wavelength is a DVD laser with a 650 nm wavelength, and the laser with the second wavelength is a CD laser with a 780 nm wavelength. If the first reflection signal is larger than the second reflection signal, the disc is recognized as a DVD, otherwise, as a CD.

Further, a DVD recognition apparatus according to this embodiment of the invention is provided. The apparatus includes at least an optical read means and a processing unit. The optical read means uses a laser with a first wavelength to irradiate a disc, thereby obtaining a first reflection signal, and uses a laser with a second wavelength to irradiate the disc, thereby obtaining a second reflection signal. The processing unit recognizes the type of disc according to the first and second reflection signals.

The laser with the first wavelength is a DVD laser with a 650 nm wavelength, and the laser with the second wavelength is a CD laser with a 780 nm wavelength. If the first reflection signal is larger than the second reflection signal, the processing unit recognizes the disc as a DVD, otherwise, as CD.

The disc recognition apparatus can be deployed in a Combo-ROM, DVD-ROM or DVD-RW ROM drive or player.

The above-mentioned method may take the form of program code embodied in a tangible media. When the program code is loaded into and executed by a machine, the machine can become an apparatus for practicing the disclosed methods.

### BRIEF DESCRIPTION OF THE DRAWINGS

The aforementioned features and advantages will become apparent by referring to the following detailed description with reference to the accompanying drawings, wherein:

FIG. 1 is an oscillogram illustrating reflection signals during a conventional disc recognition process;

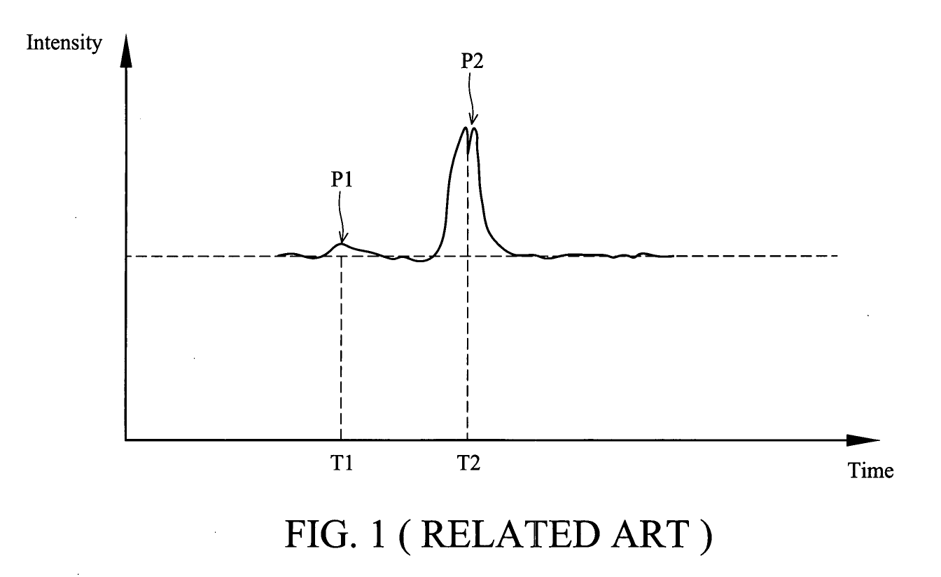

FIG. 2 is a schematic diagram illustrating the architecture of the disc recognition apparatus according to an embodiment of the invention;

FIG. 3 shows reflection signals corresponding to DVD and CD lasers irradiating to a CD; and

FIG. 4 is a flowchart showing the disc recognition method according to an embodiment of the invention.

### DETAILED DESCRIPTION

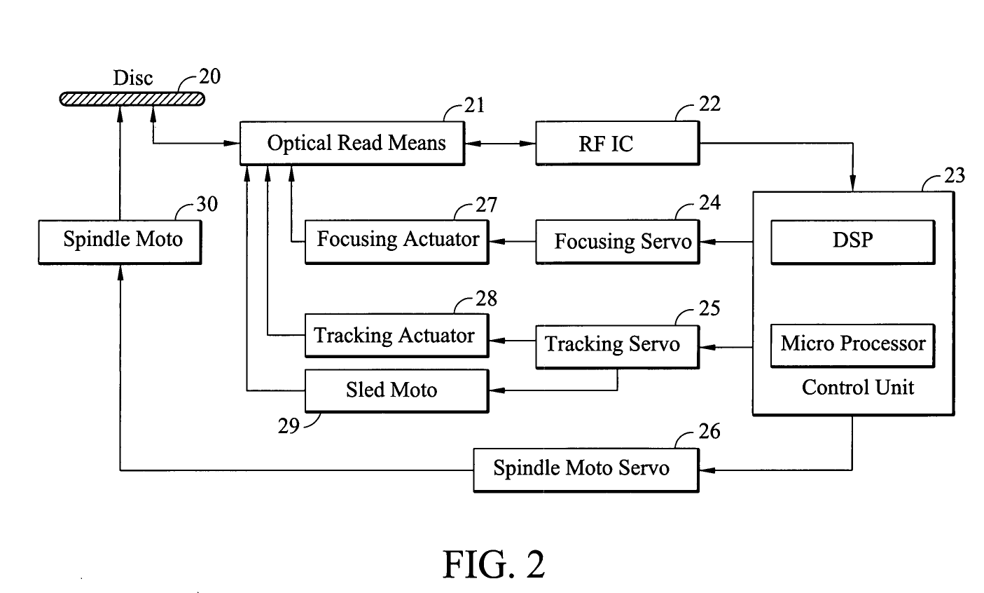

FIG. 2 illustrates the architecture of the disc recognition apparatus according to an embodiment of the invention. In this embodiment, the disc recognition apparatus may be a disc servo system, that is, the disc recognition apparatus may be applied in a DVD-ROM or recordable DVD drive or player.

The optical read means 21 reads reflection signal from the disc 20. After the signal is amplified and processed by RF (Radio Frequency) IC 22, the FE (Focusing Error) signal, TE (Tracking Error) signal and relative data and signals are input to a control unit 23 comprising a DSP (Digital Signal Processor) and a micro processor.

After the control unit 23 analyzes the received data and computes related operations, the disc type is recognized, servo driver signals are computed, and the control unit 23 outputs the signals to corresponding servos (focusing servo 24, tracking servo 25 and spindle motor servo 26) to control the actuators (focusing actuator 27, tracking actuator 28, sled motor 29 and spindle motor 30) to ensure accuracy when reading or writing data. The process of disc recognition of the control unit 23 is described later.

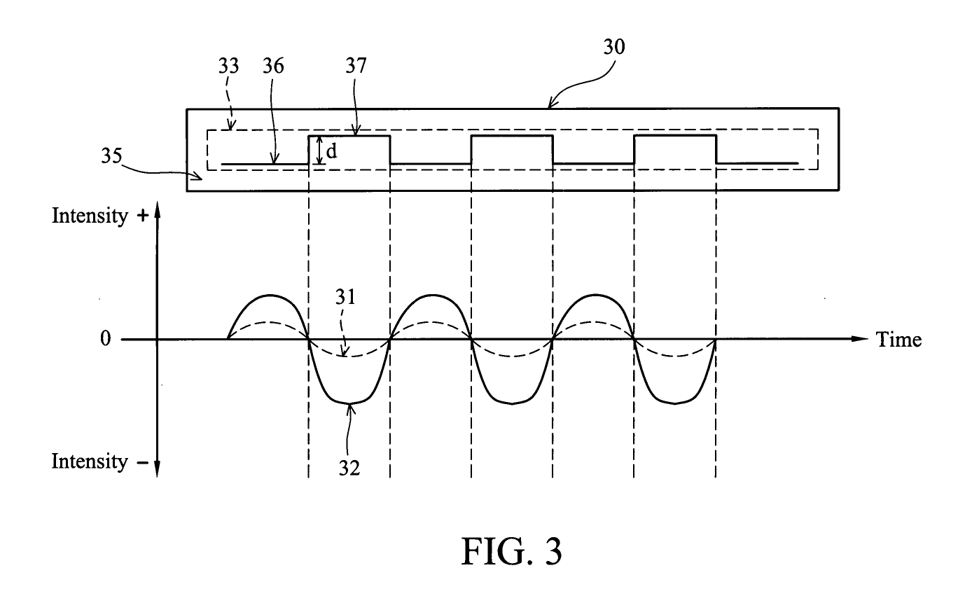

Based on design properties, respective disc types exhibit different reflective properties when irradiated by lasers with different wavelengths. For example, a disc is respectively irradiated by a DVD laser with a 650 nm wavelength and a CD laser with a 780 nm wavelength, the reflection rate corresponding to a DVD laser is larger than that corresponding to a CD laser if the disc is a DVD, and the reflection rate corresponding to a CD laser is larger than that corresponding to a DVD laser if the disc is a CD. For example, FIG. 3 shows reflection signals corresponding to DVD and CD lasers irradiating a CD 30. The disc 30 comprises a data layer 33 and a protection layer 35, and the data layer 33 includes lands 36 and pits 37 with depth d. The depth d is approximately a quarter of the wavelength of a laser. For example, depth d is 162.5 nm if the disc 30 is a DVD, and depth d is 195 nm if the disc 30 is a CD. Therefore, if a laser with a 650 nm wavelength irradiates a pit with 162.5 nm depth, since the phase difference of reflection and incident is half of the wavelength (two times a quarter of the wavelength), the reflection and incident lasers are completely counteracted to obtain a wave trough 32, and the absolute intensity of amplitude is maximum. However, if a laser with a 780 nm wavelength irradiates a pit with a 162.5 nm depth, or a laser with a 650 nm wavelength irradiates a pit with a 195 nm depth, since the phase difference of reflection and incident is not half of the wavelength, the reflection and incident lasers are not completely counteracted, thereby obtaining a wave trough 31. Obviously, the absolute intensity of amplitude corresponding to wave trough 32 is larger than that of wave trough 31. That is, the intensity of the reflection signal corresponding to a DVD laser irradiating a CD is less than that of a CD laser irradiating a CD. The above properties can be used for disc recognition.

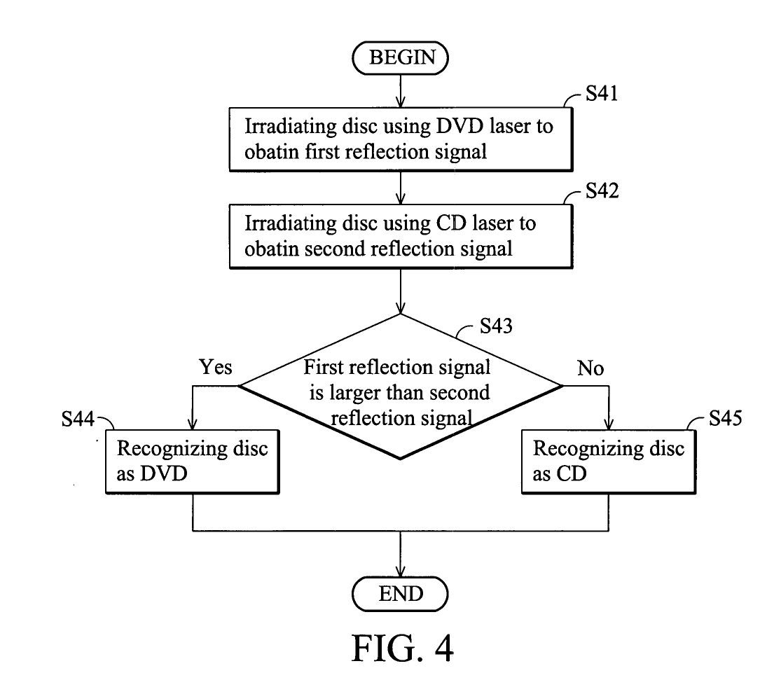

FIG. 4 is a flowchart showing the disc recognition method according to an embodiment of the invention. This embodiment of the invention is suitable for use in the disc recognition apparatus, such as for a Combo-ROM, DVD-ROM or recordable DVD drive or player.

First, in step S41, the optical read means 21 of the disc apparatus uses a laser with a first wavelength to irradiate a disc, thereby obtaining a first reflection signal. The laser with the first wavelength may be a DVD laser with a 650 nm wavelength. In step S42, the optical read means 21 of the disc apparatus uses a laser with a second wavelength to irradiate the disc, thereby obtaining a second reflection signal. The laser with the second wavelength is a CD laser with a 780 nm wavelength.

Then, in step S43, the control unit 23 recognizes the type of the disc according to the intensity of the first and second reflection signals. If the absolute intensity of the first reflection signal is larger than that of the second reflection signal (yes in step S43), in step S44, the control unit 23 recognizes the disc as a DVD, otherwise (no in step S43), in step S45, the disc is recognized as a CD.

Furthermore, the pit depth of the disc can be first determined if the absolute intensity of the first reflection signal is larger than that of the second reflection signal, and the disc type is then recognized according to the pit depth of the disc.

As described above, the intensity of a reflection signal relates to the position reflecting the signal (land or pit), and the laser wavelength. The intensity of reflection signals corresponding to a DVD laser (with a first wavelength) irradiating a CD is less than that of a CD laser (with a second wavelength) irradiating a CD. Additionally, the intensity of reflection signals corresponding to a DVD laser (with a first wavelength) irradiating a DVD is larger than that of a CD laser (with a second wavelength) irradiating to a DVD.

Embodiments of the invention provide an effective disc recognition method and apparatus that recognizes a disc according to the reflective property of a disc corresponding to lasers with different wavelengths. Compared with the conventional disc recognition methods that use only a single laser to irradiate discs and recognize a disc according to the thickness of the protection layer thereof, the embodiments of the invention prevent misdetection due to small reflected signals, thus improving the recognition accuracy.

Embodiments of the method, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the embodiment. The method and system may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed embodiment. When implemented on a general-purpose processor, the program code combines with the processor to provide a unique apparatus that operates analogously to application specific logic circuits.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

1. A disc recognition method, comprising the steps of:
irradiating a disc using a laser with a first wavelength, thereby obtaining a first reflection signal;
irradiating the disc using a laser with a second wavelength, thereby obtaining a second reflection signal; and
recognizing the type of the disc according to the first and second reflection signals.

2. The method of claim 1 further comprising determining a pit depth of the disc if an absolute intensity of the first reflection signal is larger than that of the second reflection signal.

3. The method of claim 2 further comprising recognizing the disc type according to the pit depth of the disc.

4. The method of claim 1 further comprising determining a pit depth of the disc as a quarter of the first wavelength if an absolute intensity of the first reflection signal is larger than that of the second reflection signal.

5. The method of claim 1 further comprising determining a pit depth of the disc as a quarter of the second wavelength if an absolute intensity of the first reflection signal is less than that of the second reflection signal.

6. The method of claim 1 wherein the laser with the first wavelength is a DVD laser, and the laser with the second wavelength is a CD laser.

7. The method of claim 6 further comprising recognizing the disc as a DVD if an absolute intensity of the first reflection signal is larger than that of the second reflection signal.

8. The method of claim 6 further comprising recognizing the disc as a CD if an absolute intensity of the second reflection signal is larger than that of the first reflection signal.

9. The method of claim 1 wherein the first wavelength is 650 nm, and the second wavelength is 780 nm.

10. A disc recognition apparatus, comprising:
an optical read means using a laser with a first wavelength to irradiate a disc, thereby obtaining a first reflection signal, and using a laser with a second wavelength to irradiate the disc, thereby obtaining a second reflection signal; and
a control unit coupled to the optical read means to recognize the type of the disc according to the first and second reflection signals.

11. The apparatus of claim 10 wherein the control unit further determines a pit depth of the disc if an absolute intensity of the first reflection signal is larger than that of the second reflection signal.

12. The apparatus of claim 11 wherein the control unit further recognizes the disc type according to the pit depth of the disc.

13. The apparatus of claim 10 wherein the control unit further determines a pit depth of the disc as a quarter of the first wavelength if an absolute intensity of the first reflection signal is larger than that of the second reflection signal.

14. The apparatus of claim 10 wherein the control unit further determines a pit depth of the disc as a quarter of the second wavelength if an absolute intensity of the first reflection signal is less than that of the second reflection signal.

15. The apparatus of claim 10 wherein the laser with the first wavelength is a DVD laser, and the laser with the second wavelength is a CD laser.

16. The apparatus of claim 15 wherein the control unit further recognizes the disc as a DVD if an absolute intensity of the first reflection signal is larger than that of the second reflection signal.

17. The apparatus of claim 15 wherein the control unit further recognizes the disc as a CD if an absolute intensity of the second reflection signal is larger than that of the first reflection signal.

18. The apparatus of claim 10 wherein the first wavelength is 650 nm, and the second wavelength is 780 nm.
